(19) United States
(12) Patent Application Publication
(10) Pub. No.: US 2024/0404024 A1
(43) Pub. Date: Dec. 5, 2024

(54) IMAGE CAPTURE APPARATUS, ELECTRONIC DEVICE, AND CONTROL METHOD THEREFOR

(71) Applicant: CANON KABUSHIKI KAISHA, Tokyo (JP)

(72) Inventors: KAZUKI KONISHI, Tokyo (JP); RYUICHIRO YASUDA, Tokyo (JP); YU NARITA, Kanagawa (JP)

(21) Appl. No.: 18/663,509

(22) Filed: May 14, 2024

(30) Foreign Application Priority Data
May 29, 2023 (JP) 2023-088074
Feb. 22, 2024 (JP) 2024-025573

(51) Int. Cl. G06T 5/73; G06T 5/20; G06T 7/254

(52) U.S. Cl. CPC G06T 5/73; G06T 5/20; G06T 7/254; G06T 2207/20024

(57) ABSTRACT

An image capture apparatus that performs subject blur correction for suppressing a positional change in time of a main subject in an image is disclosed. The apparatus determines if a motion of the main subject is a specific motion and, in a case where the motion of the main subject is determined to be the specific motion, makes a degree of subject blur correction less than that of before the specific motion is determined.

### BACKGROUND OF THE INVENTION

### Field of the Invention

The present invention relates to an image capture apparatus, an electronic device, and a control method therefor.

### Description of the Related Art

A known subject blur correction function (Japanese Patent Laid-Open No. 2017-215350) controls the change in position of a subject (subject blur) in a captured image by controlling the cropping position and driving a correction lens according to the position of a specific subject.

If the movement direction and speed of the specific subject is constant, the detection or prediction accuracy of the subject position is increased, which leads to the accuracy of the subject blur correction also being increased. However, if the movement direction and speed of the specific subject are not constant, the detection or prediction accuracy of the subject position is decreased. For example, in the case of an action including a back and forth motion such as in a case where a specific subject repeatedly performs a jump action, each time the movement direction reverses, the detection or prediction accuracy of the subject position decreases. As a result, in the captured moving image, the position of the specific subject and the background may not be stable.

### SUMMARY OF THE INVENTION

According to an aspect of the present invention, an image capture apparatus and an electronic device that can appropriately apply a subject blur correction function and a control method therefor are provided.

According to an aspect of the present invention, there is provided an image capture apparatus that performs subject blur correction for suppressing a positional change in time of a main subject in an image, comprising: one or more processors that execute a program stored in a memory and thereby function as: a determination unit configured to determine if a motion of the main subject is a specific motion; and a control unit configured to unit, in a case where the motion of the main subject is determined unit to be the specific motion, control the image capture apparatus so as to make a degree of subject blur correction less than that of before the specific motion is determined.

According to another aspect of the present invention, there is provided an electronic device, comprising: one or more processors that execute a program stored in a memory and thereby function as: a controlling unit that controls processing to suppress a change in a position of a main subject across a plurality of images of a moving image obtained using an image capture unit, wherein in a case where the main subject is performing a first motion of repeatedly moving back and forth in a first direction and a second direction, which is a reverse direction of the first direction, relative to the image capture unit during moving image capture, the controlling unit controls the processing so that a degree of suppressing the change in the position of the main subject is less than in a case where the main subject is performing a second motion different from the first motion relative to the image capture unit during moving image capture.

According to a further aspect of the present invention, there is provided a control method executed by an image capture apparatus capable of subject blur correction for suppressing a change in a position of a main subject in an image, comprising: determining if a motion of the main subject is a predetermined specific motion; and in a case where the motion of the main subject is determined to be the specific motion, controlling the image capture apparatus to make a degree of subject blur correction less than that of before the specific motion is determined.

According to another aspect of the present invention, there is provided a control method executed by an electronic device that controls processing to suppress a change in a position of a main subject across a plurality of images of a moving image obtained using an image capture unit, comprising: in a case where the main subject is performing a first motion of repeatedly moving back and forth in a first direction and a second direction, which is a reverse direction of the first direction, relative to the image capture unit during moving image capture, controlling the processing so that a degree of suppressing the change in the position of the main subject is less than in a case where the main subject is performing a second motion different from the first motion relative to the image capture unit during moving image capture.

Further features of the present invention will become apparent from the following description of exemplary embodiments (with reference to the attached drawings).

### BRIEF DESCRIPTION OF THE DRAWINGS

FIG. 1 is a block diagram illustrating a functional configuration example of a digital camera representing an image capture apparatus according to an embodiment.

FIG. 2 is a flowchart relating to control operations of subject blur correction according to an embodiment.

FIG. 3 is an example of a circuit diagram of a low-pass filter usable in an embodiment.

FIG. 4A is a flowchart relating to a main subject motion determination operation according to a first embodiment.

FIG. 4B is a flowchart relating to the main subject motion determination operation according to the first embodiment.

FIG. 5 is a flowchart relating to a main subject motion determination operation according to a second embodiment.

FIG. 6 is a flowchart relating to a main subject motion determination operation according to a third embodiment.

FIGS. 7A to 7C are diagrams relating to main subject motion determination methods 2 and 3 according to the third embodiment.

FIGS. 8A and 8B are flowcharts relating to a main subject motion determination operation according to a fourth embodiment.

FIGS. 9A and 9B are diagrams relating to main subject motion determination method 1 according to the third embodiment.

FIGS. 10A to 10C are diagrams illustrating examples of outputs of a determination index according to the first embodiment.

FIGS. 11A to 11D are diagrams illustrating examples of time series shifts in main subject position and LPF output according to the first embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that in the embodiments described below, the present invention is implemented as a digital camera. However, the present invention can also be implemented as any electronic device with an image capture function. Examples of such an electronic apparatus include video cameras, computer devices (personal computers, tablet computers, media players, PDAs, and the like), mobile phones, smartphones, game consoles, robots, drones, and drive recorders. These are examples, and the present invention can be implemented as other electronic devices.

### First Embodiment

### Configuration of Digital Camera 1

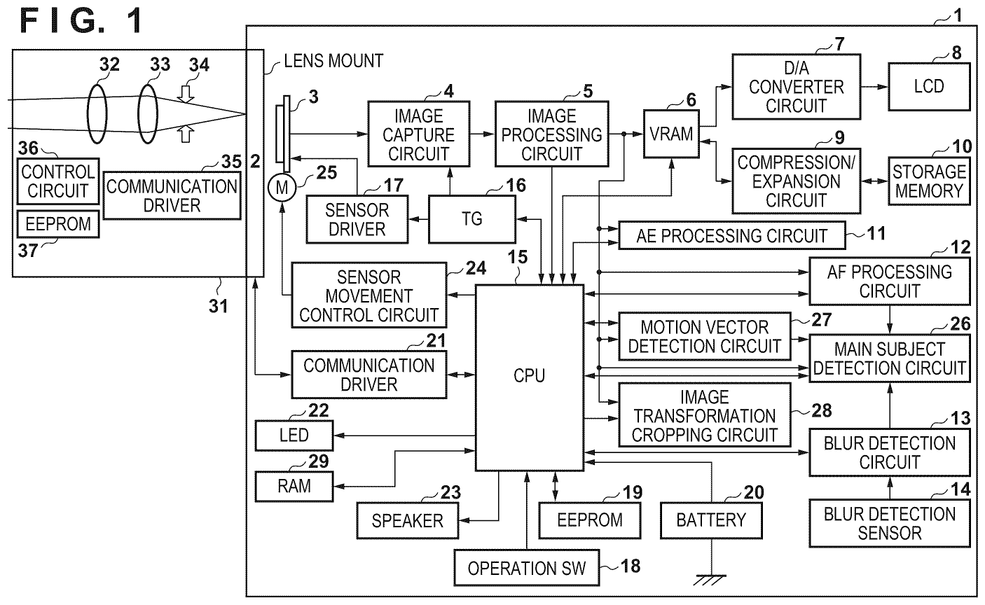

FIG. 1 is a block diagram illustrating an example of the functional configuration of a digital camera 1 with an interchangeable lens, which is an example of an image capture apparatus capable of implementing the present invention. In the state illustrated in FIG. 1, an interchangeable lens 31 is mounted on the digital camera 1.

The interchangeable lens 31 is detachably mounted on a lens mount 2 provided on the digital camera 1. The interchangeable lens 31 and the lens mount 2 are provided with terminals configured to come into contact with one another when the interchangeable lens 31 is mounted on the lens mount 2. Power is supplied to the interchangeable lens 31 from the digital camera 1 via the terminals. Also, a CPU 15 of the digital camera 1 and a control circuit 36 of the interchangeable lens 31 can communicate with one another via the terminals.

The interchangeable lens 31 includes an imaging optical system for forming an optical image of a subject on an imaging plane of an image sensor 3. The imaging optical system is constituted by a plurality of lenses including a movable lens. In this example, a blur correction lens 32 and a focus lens 33 are examples of a movable lens.

A diaphragm 34 can adjust the opening amount. The opening amount of the diaphragm 34 is controlled by the control circuit 36 according to a command from the CPU 15. The opening amount (F-number) of the diaphragm 34 can also be manually changed by the user.

A communication driver 35 supports the communication with a communication driver 21 on the camera side.

The control circuit 36 is a microprocessor, for example, and by loading a program stored in an EEPROM 37 onto an internal memory and executing the program, the control circuit 36 controls the driving of the movable lens and the opening amount of the diaphragm, transmits information of the interchangeable lens 31 to the digital camera 1, and the like.

The EEPROM 37 stores unique information and setting values of the interchangeable lens 31, programs to be executed by the control circuit 36, and the like.

The image sensor 3, for example, may be a known CCD or CMOS color image sensor including a primary color Bayer array color filter. The image sensor 3 includes a pixel array including a plurality of pixels in a two-dimensional array and a peripheral circuit for reading signals from the pixels. Each pixel accumulates a charge corresponding to the amount of incident light via photoelectric conversion. By reading a signal including voltage corresponding to the amount of charge accumulated in the exposure period from each pixel, a pixel signal group (analog image signal) representing a subject image to be formed on an imaging surface by the imaging optical system of the interchangeable lens 31 is obtained.

An image capture circuit 4 applies noise reduction processing, gain, and the like to analog image signals.

An image processing circuit 5 A/D converts a signal output by the image capture circuit 4 and converts this into image data and applies a predetermined image processing to generate image data for display and image data for storing.

The image processing that can be applied by the image processing circuit 5 may include, for example, preprocessing, color interpolation processing, correction processing, data editing processing, special effects processing, and the like.

The preprocessing may include signal amplification, reference level adjustment, defective pixel correction, and the like.

The color interpolation processing is processing for interpolating values of color components not included in the pieces of pixel data forming the image data that is executed in a case where a color filter is provided in the image sensor. Color interpolation processing may be referred to as demosaic processing.

Correction processing may include various processing including white balance adjustment, gradation correction, correction (image restoration) of image degradation caused by an optical aberration in the imaging optical system 101, correction of the effects of vignetting of the imaging optical system 101, color correction, and the like.

The data editing processing may include processing such as combining, scaling, and the like. Generating image data for display and image data for storing may also be included in the data editing processing.

Special effects processing may include processing including adding a blur effect, changing color tone, relighting, and the like.

Note that these are examples of the processing that can be applied by the image processing circuit 5, and are not intended to limit the processing applied by the image processing circuit 5. The image data processed by the image processing circuit 5 is supplied to various functional blocks according to their application.

VRAM 6 is used to store the image data for display as well as buffer memory for the image data for storing. The image data for display stored in the VRAM 6 is displayed on an LCD 8, a display apparatus, after being converted into an analog image signal of a format suitable for display by a D/A converter circuit 7.

A compression/expansion circuit 9 encodes the image data for storing stored in the VRAM 6 to reduce the data amount. The compression/expansion circuit 9 also generates a data file storing the encoded image data and stores the data file in memory for storing 10. The compression/expansion circuit 9 also reads out the image data stored in the memory for storing 10, decodes the image data, and stores it in the VRAM 6.

The memory for storing 10 may be a detachable storage medium such as a memory card, for example. The memory for storing 10 is used for storing the image data captured by the digital camera 1.

An AE processing circuit 11 calculates a predetermined AE evaluation value on the basis of the image data output by the image processing circuit 5. Also, the AE processing circuit 11 executes automatic exposure control (AE) processing to determine the capturing conditions on the basis of the AE evaluation value. The AE processing circuit 11 notifies the CPU 15 of the determined capturing conditions. The CPU 15 transmits the target F-number of the diaphragm 34 to the interchangeable lens 31 via the communication driver 21. When this command is received via the communication driver 35, the control circuit 36 of the interchangeable lens 31 drives the diaphragm 34 to become the F-number according to the command.

An AF processing circuit 12 calculates a predetermined AF evaluation value on the basis of the image data output by the image processing circuit 5. Also, the AF processing circuit 12 executes automatic focus detection (AF) processing to determine the target position of the interchangeable lens 31 on the basis of the AF evaluation value. The AF processing circuit 12 notifies the CPU 15 of the determined target position. The CPU 15 transmits a command to the interchangeable lens 31 to move the focus lens 33 to the target position via the communication driver 21. When the control circuit 36 of the interchangeable lens 31 receives this command via the communication driver 35, the control circuit 36 moves the focus lens 33 to the position according to the command.

A blur detection sensor 14 outputs a signal according to the motion of the digital camera 1. The blur detection sensor 14, for example, is a gyro sensor or an acceleration sensor and outputs a signal according to motion in the three orthogonal axes and about the three axes.

A blur detection circuit 13 processes the output signal of the blur detection sensor 14 and supplies the detected motion of the digital camera 1 to the CPU 15 and a main subject detection circuit 26.

The CPU 15 is a control unit of the digital camera 1. The CPU 15 loads a program stored in an EEPROM 19 onto a RAM 29 and executes the program to control the operations of the units of the digital camera 1 and implement the functions of the digital camera 1. Also, the CPU 15 communicates with the control circuit 36 of the interchangeable lens 31 and controls the operations of the interchangeable lens 31.

Also, the CPU 15 according to the present embodiment determines whether the main subject is moving back and forth on the basis of the subject position detected by the main subject detection circuit 26 and stops the subject blur correction of the main subject in a case where the main subject is determined to be moving back and forth. This will be described below in detail. Moving back and forth is a motion where the movement direction repeatedly reverses, and in the case of a human subject, this may be a rocking motion of the body from side to side or repeated jumps upward.

The EEPROM 19 stores programs executed by the CPU 15, various types of setting values for the digital camera 1, GUI data, and the like. The RAM 29 is a main memory used by the CPU 15 when loading and executing a program. Note that the RAM 29 and the VRAM 6 may be different areas within the same memory space.

A timing generation circuit (TG) 16 generates a timing signal for controlling the operations of the image sensor 3, the image capture circuit 4, and the CPU 15.

A sensor driver 17 controls the operations of the image sensor 3 in according with the timing signals output by the TG 16.

An operation switch (SW) 18 is a generic term for an input device (buttons, switches, dials, and the like) that is provided for the user to input various instructions to the digital camera 1. Each of the input devices constituting the operation SW 18 has a name corresponding to the function assigned to it. For example, the operation SW 18 includes a release switch, a moving image recording switch, a shooting mode selection dial for selecting a shooting mode, a menu button, a directional key, an enter key, and the like. The release switch is a switch for recording a still image, and the CPU 15 recognizes a half-pressed state of the release switch as an image capture preparation instruction and a fully-pressed state of the release switch as an image capture start instruction. Also, the CPU 15 recognizes a press of the moving image recording switch during an image capture standby state as a moving image recording start instruction and a press of the moving image recording switch during the recording of a moving image as a recording stop instruction.

A battery 20 is a battery pack, for example, and supplies the power necessary for the digital camera 1 and the interchangeable lens 31 to operate.

The communication driver 21 supports the communication with the communication driver 35 of the interchangeable lens 31 mounted on the lens mount 2.

An LED 22 is a display element used to display the operation status of the digital camera 1, warnings, and the like.

A speaker 23 is used to output an alarm, audio guidance, or the like.

A sensor movement motor 25 movies the image sensor 3 in the horizontal direction, vertical direction, and rotation direction. The operations of the sensor movement motor 25 are controlled by the CPU 15 via a sensor movement control circuit 24.

A motion vector detection circuit 27 detects a motion vector of a subject in an image on the basis of the image data output by the image processing circuit 5, for example, the data of a plurality of frames of moving images. The motion vector detection circuit 27, for example, detects a motion vector in each region of a divided image and outputs the detection result to the main subject detection circuit 26 and the CPU 15.

The main subject detection circuit 26 detects a main subject region in the image from the image data output by the image processing circuit 5. The main subject detection circuit 26 outputs information such as the position, size, reliability, and the like of the detected main subject region.

For example, the main subject detection circuit 26 can separate the image into background regions and subject regions on the basis of the motion vector detected by the motion vector detection circuit 27 and detect the subject region closest to the center as the main subject region, for example.

Alternatively, in a case where the type of the main subject is specified in advance, the main subject detection circuit 26 may detect feature regions corresponding to the main subject and set one of the detected feature regions as the main subject region. The main subject detection circuit 26, for example, can detect a face region or a head region of a person as a feature region using a known method and set the feature region that is the largest, that is the closest to the center, or that has a focus detection area set as the main subject region.

Also, in a case where information of the main subject region specified by the user is obtained via the CPU 15, the main subject detection circuit 26 may detect the main subject region in the next frame on the basis of the motion vector detected for the main subject region. Alternatively, the main subject detection circuit 26 may detect a region with a specific color as the feature region.

Also, the main subject detection circuit 26 may obtain information of the defocus amount in the image from the AF processing circuit 12 and detect the region with the smallest difference in the defocus amount with the previous frame (degree of focus is most similar) as the feature region.

The method is not limited to the method described here, and the main subject detection circuit 26 can detect the main subject region via any known method using one or more of a motion vector, defocus amount, set AF frame, user-specified region, feature region detection result, and the like. Note that the main subject detection circuit 26 may detect a plurality of main subject regions. In this case, the main subject detection circuit 26 may provide an order to the main subject regions on the basis of similarity to the main subject.

An image transformation cropping circuit 28 applies rotation, enlargement, reduction, cropping, and the like to the image data output by the image processing circuit 5.

Though described below in detail, in the present embodiment, the position where the image transformation cropping circuit 28 crops the image region is controlled by the CPU 15 on the basis of the position of the main subject region to correct subject blur. In other words, by changing the position where a partial image including the main subject is cropped from the image obtained using the image sensor 3, a change in position of the main subject is suppressed. Note that in a case where a plurality of main subject regions are detected, the main subject region highest in the order of similarity to the main subject is set as the target. The image transformation cropping circuit 28 stores the processed image data in an area of the VRAM 6 according to its application.

Note that the CPU 15, for example, can execute camera shake blur correction by moving the blur correction lens 32 and/or the image sensor 3 on the basis of the output of the blur detection circuit 13.

### Blur Correction Control

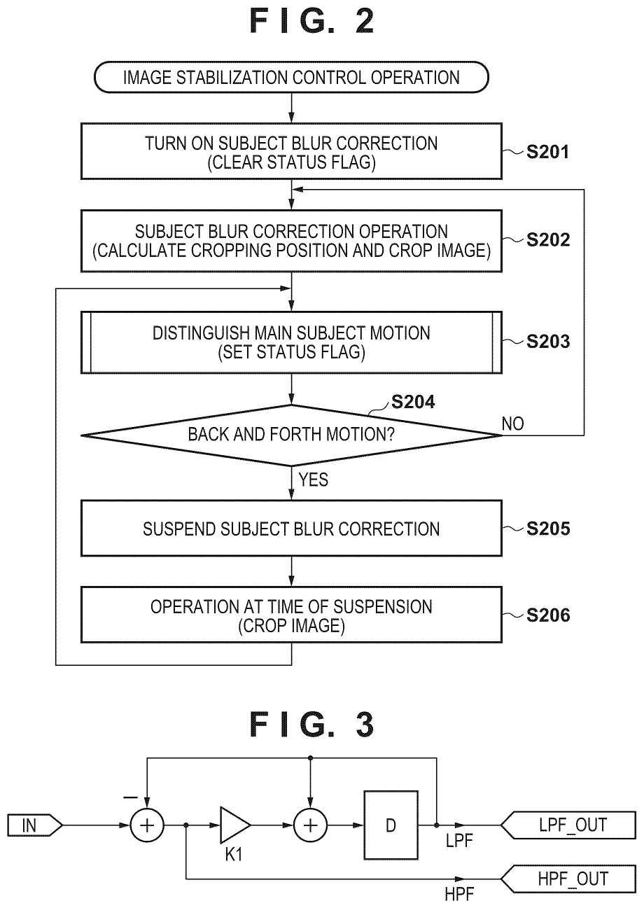

Next, the blur correction control operations executed by the digital camera 1 according to the present embodiment will be described using the flowchart illustrated in FIG. 2. This operation is implemented by the CPU 15 executing a program to control the operation of each unit. Also, this operation is executed when the digital camera 1 is in the process of capturing a moving image and when the subject blur correction function is set to on. Note that the moving image being captured may be for live view display or for recording.

In the case of capturing a moving image for recording, in addition to the moving image data for recording, moving image data for display is also generated and live view displayed on the LCD 8. Note that in this example, the operations relating to blur correction are described, and the description of other processing executed during moving image capture, such as AE processing, AF processing, display processing, storage processing, and the like, is omitted.

During the capture of moving image, image data of each frame, for example, is supplied from the image processing circuit 5 to the AE processing circuit, the AF processing circuit 12, the motion vector detection circuit 27, the main subject detection circuit 26, and the image transformation cropping circuit 28. Then, each of these circuits executes the processing described above. Note that each of these circuits may not execute processing on all of the frames for which image data is supplied from the image processing circuit 5.

In step S201, to enable the subject blur correction to be executed, the CPU 15 sets the value of a status flag which is set to 1 when the subject blur correction is suspended to 0.

In step S202, the CPU 15 executes the subject blur correction. As described above, in order to suppress a change in position of the main subject region in the image, the CPU 15 controls the position where the image transformation cropping circuit 28 crops the image to correct the subject blur.

The subject blur correction operation will be described in detail below.

The CPU 15 obtains an output signal of the blur detection circuit 13 and a detection result of a main subject region from the main subject detection circuit 26. The CPU 15 applies low-pass filter processing (LPF processing) to the position information (for example, the image coordinates corresponding to the center or centroid of the region) included in the detection result of the main subject region. By applying LPF processing, a detection processing error or motion (for example, momentarily hiding the face) of the main subject that should not be reflected in the detection result affecting the detection result can be suppressed.

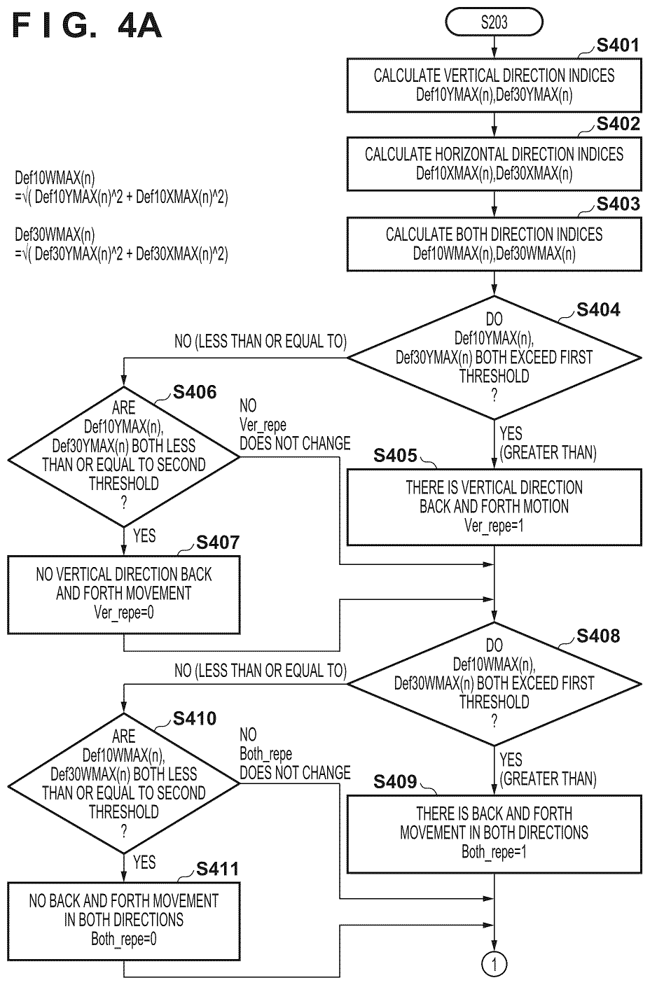

The cut-off frequency of the LPF processing can be determined taking into account the characteristics of the motion of the main subject (for example, approximately 2 to 3 Hz). Also, the LPF processing can be implemented by the CPU 15 applying an operation for obtaining a low-pass filter output (LPF_OUT) to the position information using a digital filter with a configuration such as that illustrated in FIG. 3, for example.

For the position information of the main subject region, the CPU 15 applies the operation indicated by the following formula to the coordinates in the horizontal direction and the coordinates in the vertical direction to obtain the LPF output (LPF_OUT).

$$LPFoutX ( n ) = K 1 \cdot [ CX ( n ) - LPFoutX ( n - 1 ) ] + LPFoutX ( n - 1 )$$

$$LPFoutY ( n ) = K 1 \cdot [ CY ( n ) - LPFoutY ( n - 1 ) ] + LPFoutY ( n - 1 )$$

CX (n): coordinates in the horizontal direction of the main subject region at time n

CY (n): coordinates in the vertical direction of the main subject region at time n

LPFoutX (n): LPF output in the horizontal direction at time n LPFoutY (n): LPF output in the vertical direction at time n

Note that the coordinates are values in a predetermined image coordinate system.

Note that the value of K1 is determined by the cut-off frequency. For example, if the cut-off frequency is set to 2 Hz and the sampling frequency is set to 30 Hz, the value is approximately 0.3463.

The cut-off frequency can be determined on the basis of the characteristics of the back and forth motion of the main subject targeted for detection. In determining the cut-off frequency, the frame rate and the exposure time at the time of moving image capture may not be taken into account. For example, the frequency of back and forth motion up and down that occurs when a person walks or runs, for example, may be empirically measured in advance, and the cut-off frequency for cutting unnecessary motion such as the motion of momentarily hiding the face, without cutting the measured frequency, may be prestored in the EEPROM 19. Alternatively, a measurement period for measuring the characteristics of the back and forth motion of the main subject targeted for detection may be provided, and a change in the motion vector of the main subject may be measured on the basis of the image data of each frame obtained in the measurement period and an appropriate cut-off frequency may be calculated.

The values (LPFoutX (n) and LPFoutY (n) of the LPF output are set as the position of the main subject region, and the CPU 15 controls the cropping position of the image transformation cropping circuit 28. For example, the CPU 15 calculates the cropping position (target position) of the image so that the position of the main subject region remains in the center of the image or at the position it was in at the start of recording. Then, the CPU 15 outputs the calculated cropping position (target position) as subject blur correction position information to the image transformation cropping circuit 28. Note that the amount of the change from the previous cropping position may be used as the subject blur correction position information.

In a case where the subject blur correction is executed to position the main subject region in the center of the image, the subject blur correction position information corresponds to coordinates [LPFoutX (n)−r·X/2, LPFoutY (n)−r·Y/2], for example.

Also, in a case where the subject blur correction is executed to keep the main subject region at the position (SX, SY) it was in at the start of recording, the subject blur correction position information corresponds to coordinates [(1−r) X/2+LPFoutX (n)−SX, (1−r) Y/2+LPFoutY (n)−SY], for example.

Here, r is the cropping ratio with respect to the overall image size. In the case of cropping a region with a size of 70% in the horizontal direction and the vertical direction, r=0.7 (r<1). Also, X and Y are the number of pixels in the horizontal direction and the vertical direction of the image.

Note that the minimum value of the coordinates constituting the subject blur correction position information is 0, and the maximum value is (1−r)·X (horizontal direction) or (1−r)· Y (vertical direction).

The image transformation cropping circuit 28 crops a portion of the image according to the subject blur correction position information output from the CPU 15 and stores the cropped image in the VRAM 6.

In step S203, the CPU 15 determines if the main subject has a specific motion, in particular, if the main subject is moving back and forth, and sets a subject blur correction operation status flag to a value corresponding to the determination result. The operations of step S203 will be described below in detail. Here, a specific motion is not limited to moving back and forth and may be a motion with a possibility of causing the subject blur correction to lower the quality of the captured image. What kind of motion corresponds to a specific motion can be assumed in advance according to the specific subject blur correction method or the like. Thus, it can be preinstalled together with the detection method in the program executed by the CPU 15.

In step S204, the CPU 15 references the value of the status flag of the subject blur correction operation and executes step S205 if the main subject is performing the specific motion. Here, if the status flag includes a value indicating the detection of motion including back and forth motion in the vertical direction or the horizontal direction, the CPU 15 determines that the main subject is performing the specific motion. On the other hand, if the main subject is not performing the specific motion, the CPU 15 returns the processing to step S202 and continues or resumes the execution of the subject blur correction.

In step S205, the CPU 15 suspends the execution of the subject blur correction. Also, the CPU 15 obtains the cropping position for the image transformation cropping circuit 28 while the subject blur correction is suspended. The cropping position during the suspension of the subject blur correction is a fixed value. This fixed value may be the last cropping position, for example, or may be determined by the CPU 15 according to another condition. Note that instead of suspending the execution of the subject blur correction, the strength of the subject blur correction (strength of suppressing a change in position of the main subject region in the image) may be reduced below the strength in step S202.

The CPU 15 can execute camera shake blur correction by moving the blur correction lens 32 and/or the image sensor 3 on the basis of the output of the blur detection circuit 13 independent of the subject blur correction, for example. During the suspension of the subject blur correction, the CPU 15 may change the cropping position of the image targeted for camera shake blur correction. For example, the CPU 15 can change the cropping position of the image so that motion in a range that cannot be corrected by driving the blur correction lens 32 and/or the image sensor 3 is corrected.

In step S206, the CPU 15 outputs the subject blur correction position information including the fixed value obtained in step S205 to the image transformation cropping circuit 28. The image transformation cropping circuit 28 crops the image according to the fixed position indicated by the subject blur correction position information and stores the cropped image in the VRAM 6. The CPU 15 repeats the processing from step S203. Note that while the specific motion of the main subject is being continuously detected, the processing of step S205 may be skipped.

In this manner, the CPU 15 may suspend the subject blur correction while the specific motion of the main subject is being detected.

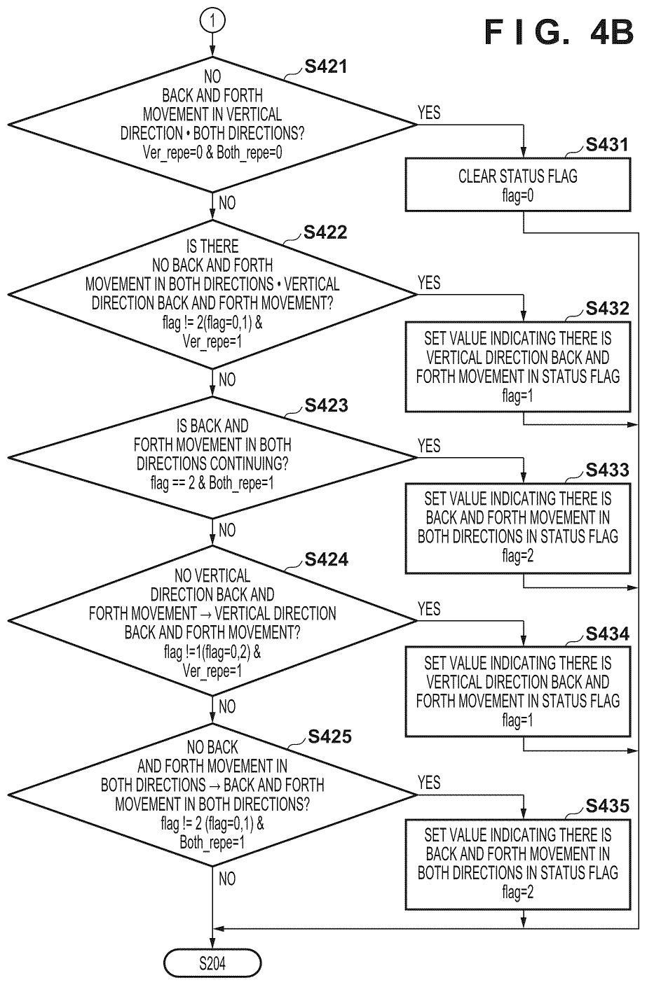

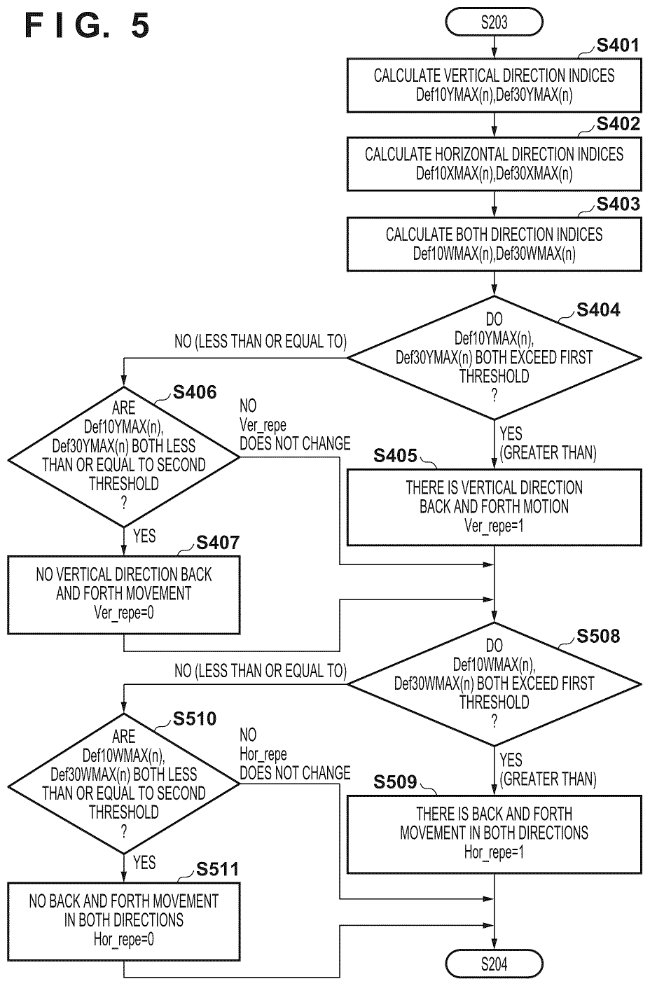

The motion determination processing of step S203 will now be described in detail using the flowchart illustrated in FIGS. 4A and 4B.

In step S401, the CPU 15 calculates the index relating to the motion of the main subject in the vertical direction of the image. Specifically, the CPU 15 first calculates an integration value of the absolute value of the difference between the coordinates CY ( ) in the vertical direction of the main subject region and the LPF output LPFoutY ( ) in the vertical direction.

Here, two indices of different integration periods are calculated. Specifically, the first integration period is 10 frames (for example, ⅓ seconds in the case of the moving image being captured having a frame rate of 30 fps), and the second integration period is 30 frames (1 second in the same case). Also, the integration value of the first integration period is Def10Y (n), and the integration value of the second integration period is Def30Y (n).

Note that the duration of the integration period is important, and in a case where the integration period is defined by frame number, it is a variable value based on a predetermined reference frame rate. Thus, in a case where the actual frame rate is different from the reference frame rate, the frame number defining the integration period is converted according to the actual frame rate. For example, the reference frame rate is 30 fps, and the integration period is defined as 10 frames. In this case, if the actual frame rate is 60 fps, the integration period is 20 frames.

However, in a case where the actual frame rate is less than the reference frame rate (24 fps), the frame number is not converted and may be set as the integration period (10 frames in this example) based on the reference frame rate.

Also, in a case where the exposure time of 1 frame is longer than the reading interval based on the frame rate set by the shooter, typically the exposure time is prioritized and the actual frame rate becomes less than the set frame rate. For example, in a case where the set frame rate is 60 fps, the reading interval is 1/60 seconds. However, in a case where the exposure time is 1/40 seconds (> 1/60 seconds), the upper limit of the frame rate is restricted to 40 fps. In a case where the digital camera 1 automatically sets the exposure time, the exposure time is dependent on the brightness of the captured scene. Accordingly, the frame rate may be dependent on the brightness of the captured scene.

Also, in the case of a dark scene, since the noise of the captured image increases, the accuracy of the index relating to the motion of the main subject may degrade. Thus, in a case where the brightness of the captured scene is equal to or less than a threshold (or the imaging sensitivity is equal to or greater than a threshold), the integration period may be extended to suppress a reduction in the accuracy of the index.

Consider an example where the accuracy of the index is affected by the noise of the captured image when the imaging sensitivity is greater than ISO 800. In a case where the imaging sensitivity is greater than ISO 800 due to a user setting or automatic setting, the CPU 15 can extend the integration section for calculating the index (the frame number can be increased). For example, in a case where an imaging sensitivity greater than ISO 800 is necessary for compensating for insufficient exposure time for maintaining a frame rate equal to or greater than the threshold, the CPU 15 can extend the integration section to obtain an index corresponding to an appropriate exposure amount while setting the imaging sensitivity to ISO 800. In this manner, to obtain an index with good accuracy, the integration section can be changed taken into account one or more of the frame rate, the exposure time, and the brightness of the captured scene.

Also, the CPU 15 normalizes the integration value according to each integration period. The CPU 15 normalizes an integration value Def10Y (n) of the first integration period using the ratio between the reference frame rate and the actual frame rate. This is because the threshold to be applied to the integration value Def10Y (n) is a value assumed in a case where integration is performed using the reference frame rate.

In the case of a frame rate being set which is faster than the reference frame rate (for example, 30 fps), the integration section (frame number) is increased as described above. Since the value corresponds to the frame number with the reference frame rate, the integration value is normalized by the ratio of the actual frame rate to the reference frame rate. For example, in a case where the actual frame rate is 60 fps, the integration value is ½ (=30 fps/60 fps).

Also, in a case where the frame rate is changed from the reference frame rate by prioritization of the exposure time, if the post-change frame rate is faster than the reference frame rate, the integration value is normalized according to the frame rate ratio. Also, in a case where the integration section is changed taking into account the brightness of the captured scene and the integration section (frame number) is increased more than in the case of the reference frame rate, the value is normalized to become a value of reference frame rate time according to the frame rate ratio.

On the other hand, the integration value Def30Y (n) of the second integration period is divided by the ratio between the second integration period and the first integration period and normalized. In this example, since second integration period/first integration period=3, the CPU 15 normalizes the integration value Def30Y (n) by dividing it by 3.

The CPU 15 clips the post-normalization integration value to the maximum value within the period in a certain period equal to the integration period and sets this as an index. The obtained indices are Def10YMAX (n) and Def30YMAX (n).

In step S402, the CPU 15 calculates the index relating to the motion of the main subject in the horizontal direction of the image. Excluding the use of the integration value of the absolute value of the difference between the coordinates CX ( ) of the horizontal direction of the main subject region and the LPF output LPFoutX ( ) of the horizontal direction, the calculation is similar to that in step S401. The obtained indices are Def10XMAX (n) and Def30XMAX (n).

In step S403, the CPU 15 calculates indices Def10WMAX (n) and Def30WMAX (n) relating to the motion of the main subject in both directions (in other words, the diagonal direction) including the vertical direction and the horizontal direction of the image using the following formula.

$$Def 10 W MAX ( n ) = {( Def 10 Y {MAX ( n )}^{2} + Def 10 X {MAX ( n )}^{2} )}^{1 / 2}$$

$$Def 30 W MAX ( n ) = {( Def 30 Y {MAX ( n )}^{2} + Def 30 X {MAX ( n )}^{2} )}^{1 / 2}$$

The CPU 15 determines the motion of the main subject from step S404 onward on the basis of each type of index obtained in this manner.

First, in step S404, the CPU 15 determines if both the index Def10YMAX (n) and the index Def30YMAX (n) of the vertical direction exceed a first threshold. If the CPU 15 determines that both of the indices of the vertical direction exceed the first threshold, step S405 is executed. If this is not determined, step S406 is executed.

The first threshold is dependent on the frame rate and can be empirically determined in advance, for example.

Def10WMAX (n) and Def30WMAX (n) are not dependent on the integration section due to being normalized by the integration section. However, the indices (Def10YMAX (n), Def30YMAX (n), Def10XMAX (n), and Def30XMAX (n)) are calculated using the absolute value of the difference between the coordinates of the main subject region and the LPF output and are thus dependent on the frame rate. Specifically, since the LPF effect is produced as the frame rate is slowed, the difference between the Def10YMAX (n) and the Def30YMAX (n) (difference between the Def10XMAX (n) and the Def30XMAX (n)) tends to decrease. Also, the Def10WMAX (n) and the Def30WMAX (n) corresponding to the determination indices tend to decrease.

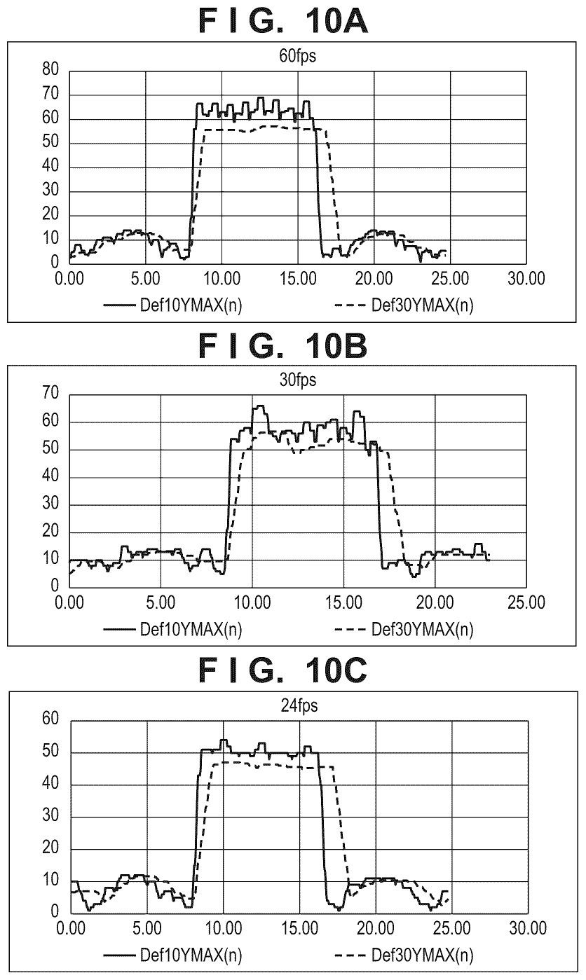

FIGS. 10A to 10C illustrate examples of the indices Def10YMAX (n) and Def30YMAX (n) for the determination of each frame rate. As illustrated in FIGS. 10A to 10C, for slower frame rates, the difference between the value of the indices in a section where there is a specific motion, such as back and forth motion, that may cause the subject blur correction to reduce the quality of the captured image and the value of the indices is decreased. Thus, the first threshold is appropriately set for each of the plurality of frame rates.

In step S405, the CPU 15 determines that the motion of the main subject includes a back and forth motion in the vertical direction and sets a variable Ver_repe to 1. Thereafter, the CPU 15 executes step S408.

In step S406, the CPU 15 determines if both of the indices Def10YMAX (n) and Def30YMAX (n) of the vertical direction are equal to or less than a second threshold. Note that the second threshold is less than the first threshold, is dependent on the frame rate for example, and can be empirically determined in advance. If the CPU 15 determines that both of the indices of the vertical direction are equal to or less than the second threshold, step S407 is executed. If this is not determined, step S408 is executed without changing the value of Ver_repe. Note that the first threshold may be the same as the second threshold.

In step S407, the CPU 15 determines that the motion of the main subject does not include a back and forth motion in the vertical direction and clears (sets to 0) the variable Ver_repe. Thereafter, the CPU 15 executes step S408.

In step S408, as in step S404, the CPU 15 determines if both of the indices Def10WMAX (n) and Def30WMAX (n) of both directions exceed the first threshold. If the CPU 15 determines that both of the indices of both directions exceed the first threshold, step S409 is executed. If this is not determined, step S410 is executed.

In step S409, the CPU 15 determines that the motion of the main subject includes a back and forth motion in both directions and sets a variable Both_repe to 1. Thereafter, the CPU 15 executes step S421 (FIG. 4B).

In step S410, as in step S406, the CPU 15 determines if both of the indices Def10WMAX (n) and Def30WMAX (n) of both directions are equal to or less than the second threshold. If the CPU 15 determines that both of the indices of the both directions are equal to or less than the second threshold, step S411 is executed. If this is not determined, step S421 (FIG. 4B) is executed without changing the value of Both_repe.

In step S411, the CPU 15 determines that the motion of the main subject does not include a back and forth motion in both directions and clears (sets to 0) the variable Both_repe. Thereafter, the CPU 15 executes step S421 (FIG. 4B).

Moving to FIG. 4B, the CPU 15 sets a value corresponding to the value of the variables Ver_repe and Both_repe with a status flag of the subject blur correction operation with the processing of step S421 onward.

In step S421, the CPU 15 determines if both of the variables Ver_repe and Both_repe are 0. If both are determined to be 0, step S431 is executed. If this is not determined, step S422 is executed.

In step S431, the CPU 15 determines that the motion of the main subject does not include a back and forth motion in either the vertical direction or both directions and clears (sets to 0) the status flag. Then, the CPU 15 ends the processing of step S203.

In step S422, the CPU 15 determines if a condition that the value of the status flag is not 2 (is 0 or 1) and a condition that the value of the variable Ver_repe is 1 are satisfied. If it is determined that the conditions are satisfied, step S432 is executed. If this is not determined, step S423 is executed.

In step S432, the CPU 15 determines that the motion of the main subject does not include a back and forth motion in both directions, but includes a back and forth motion in the vertical direction. On the basis of this determination, the CPU 15 sets the status flag to a value 1 indicating that a back and forth motion in the vertical direction has been detected (flag=1). Then, the CPU 15 ends the processing of step S203.

In step S423, the CPU 15 determines if a condition that the value of the status flag is 2 and a condition that the value of the variable Both_repe is 1 are satisfied. If it is determined that the conditions are satisfied, step S433 is executed. If this is not determined, step S424 is executed.

In step S433, the CPU 15 determines that the status of the motion of the main subject including a back and forth motion in both directions is continuing. On the basis of this determination, the CPU 15 sets the status flag to a value 2 indicating that a back and forth motion in both directions has been detected (flag=2). Then, the CPU 15 ends the processing of step S203.

In step S424, the CPU 15 determines if a condition that the value of the status flag is not 1 (is 0 or 2) and a condition that the value of the variable Ver_repe is 1 are satisfied. If it is determined that the conditions are satisfied, step S434 is executed. If this is not determined, step S425 is executed.

In step S434, the CPU 15 determines that the status has changed from a status in which the motion of the main subject does not include back and forth motion in the vertical direction to a state that does include this motion. On the basis of this determination, the CPU 15 sets the status flag to a value 1 indicating that a back and forth motion in the vertical direction has been detected (flag=1). Then, the CPU 15 ends the processing of step S203.

In step S425, the CPU 15 determines if a condition that the value of the status flag is not 2 (is 0 or 1) and a condition that the value of the variable Both_repe is 1 are satisfied. If it is determined that the conditions are satisfied, step S435 is executed. If this is not determined, the processing of step S203 ends. In a case where it is determined that the conditions are satisfied, the value of the status flag is not changed.

In step S434, the CPU 15 determines that the status has changed from a status in which the motion of the main subject does not include back and forth motion in both directions to a state that does include this motion. On the basis of this determination, the CPU 15 sets the status flag to a value 2 indicating that a back and forth motion in both directions has been detected (flag=2). Then, the CPU 15 ends the processing of step S203.

In FIGS. 4A and 4B, the value of the status flag is set on the basis of the index for the motion of the vertical direction and the index for the motion of both directions (diagonal direction). This is to control the execution or suspension of the subject blur correction according to the back and forth motion of the vertical direction with high occurrence frequency, from among back and forth motion of the vertical direction and the horizontal direction of the main subject. For example, whether to prioritize the back and forth motion of the vertical direction or the horizontal direction according to the type of the main subject may be set in advance, and whether to prioritize the back and forth motion of the vertical direction or the horizontal direction according to the type of the main subject targeted for subject blur correction may be changed.

As described above, in the present embodiment, the threshold for determining the specific motion of the main subject can be changed taking into account one or more of the imaging frame rate, the exposure time of one frame, and the brightness of the captured scene to accurately detect the specific motion of the main subject.

Also, in a case where an image capture mode is set assuming that a moving object will not be captured, the threshold for determining the specific motion of the main subject can be set lower than normal by the CPU 15. In a similar manner, as magnification (or focal length) increases, the CPU 15 can decrease the threshold for determining the specific motion of the main subject. By decreasing the threshold, subject blur correction becomes easier to suspend, allowing background fluctuations caused by the motion of the digital camera 1, such as hand shake, to be make less noticeable. Examples of the image capture mode assumed to not capture a moving object include but are not limited to a macro mode, a flower mode, a landmark mode, and the like.

Also, as the background contrast increases, the CPU 15 can decrease the threshold for determining the specific motion of the main subject. Since background fluctuations tend to be noticeable when the background contrast is high, the threshold is decreased and the subject blur correction is made easier to suspend. Note that a high-pass filter (or a band-pass filter) can be applied to a signal of the brightness value of regions of the captured image other than the region where the main subject exists, and the maximum value or integration value can be obtained as the index of the background contrast. The method for separating the background image from the image may be any known method. Also, the index relating to the background region contrast may be an index used for automatic focus detection based on contrast. Also, the CPU 15 can apply FFT, for example, to the background region and obtained the spatial frequency spectrum. If the ratio of the spatial frequency component equal to or greater than a predetermined threshold is equal to or greater than a threshold, the CPU 15 can determine that the background region contrast is high.

Note that in a case where the frame rate or the like does not satisfy a predetermined condition, determination to suspend the subject blur correction may not be executed. In the present embodiment, an index for determining if there is a specific motion of the main subject is calculated using the absolute value of the difference between the coordinates of the main subject region from the main subject detection circuit 26 and the LPF output. Thus, as described above, when the frame rate is decreased, the determination accuracy using the index may be reduced.

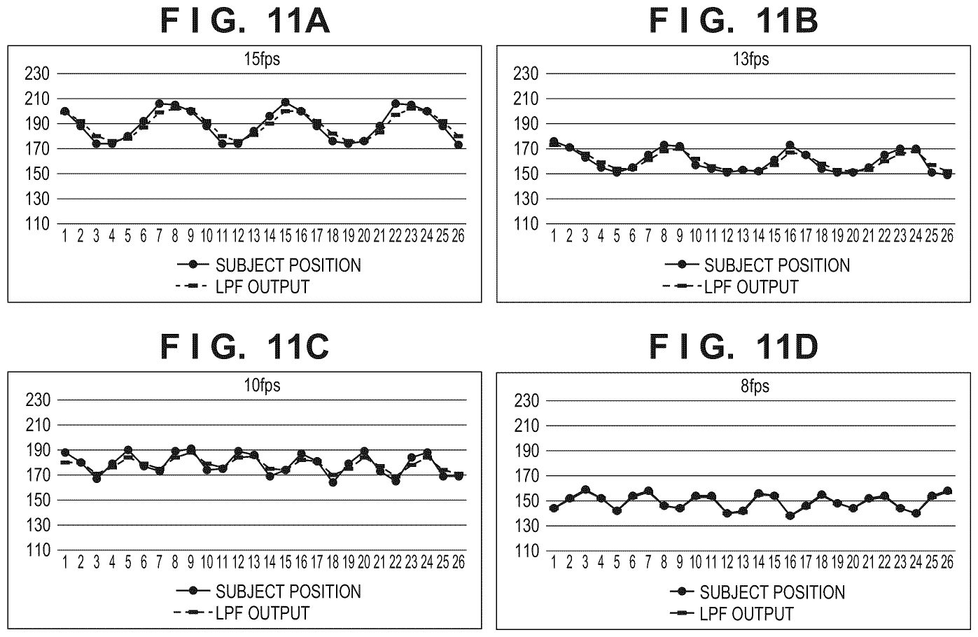

FIGS. 11A to 11D illustrate examples of change over time of the coordinates (subject position) of the main subject region and the signal value of the LPF output when the same scene is captured at a frame rate of 15 fps, 13 fps, 10 fps, and 8 fps. At a frame rate of 15 fps, the periodic motion of the main subject is evident, and the difference between the coordinates and the LPF output can be clearly observed. However, when the frame rate is 13 fps or less, the amplitude of the change in the coordinates of the main subject is reduced and the distortion in the waveform becomes more evident. The difference between the change in coordinates and the LPF output also decreases, and at a frame rate of 8 fps, there is almost no difference.

In this manner, it is difficult to detect a specific motion that can cause the subject blur correction to reduce the quality of the captured image as the frame rate is decreased. Thus, if the frame rate is equal to or less than a threshold, the CPU 15 may suspend the subject blur correction without executing a determination. The frame rate being equal to or less than the threshold is not limited to being caused by an explicit frame rate setting. For example, the frame rate may be equal to or less than the threshold in a case where the exposure time per frame is longer than a predetermined number of seconds due to a user setting or automatic exposure control.

In a similar manner, in a case where the imaging sensitivity is equal to or greater than a threshold, the CPU 15 may unconditionally suspend the subject blur correction instead of adjusting the duration of the integration section.

Also, in a case where an image capture mode that assumes not to capture a moving object, instead of the threshold for determining the specific motion of the main subject being set lower than normal, the CPU 15 may unconditionally suspend the subject blur correction from the perspective of false detection prevention.

Also, in a case where the focal length of the interchangeable lens 31 is shorter (wide-angle side) than a predetermined focal length or in the case of a change at the zoom lens to the wide-angle side of a predetermined focal length, from the perspective of false detection prevention, the determination itself to suspend the subject blur correction may not be executed. This also applies to cases where a specific lens such as a fisheye lens is mounted, cases where zoom is operated to the wide-angle of a predetermined focal length, and the like.

In the case of capturing images using a function of the present invention with a lens with a short focal length, it can be expected that images are captured in close proximity to the subject, such as in miniature photography. Thus, in a case where a moving object moves greatly outside of a predetermined range, since the background is captured in miniature, the motion can be considered to be relatively unnoticeable.

As described above, in the present embodiment, in a case where the motion of the main subject targeted for subject blur correction is detected to be a specific motion, such as a back and forth motion, that can cause the subject blur correction to reduce the quality of the captured image, execution of the subject blur correction is suspended. Thus, a reduction in the quality of the captured image caused by the subject blur correction can be suppressed.

Also, under conditions where the specific motion determination accuracy may be reduced, by making execution of the subject blur correction easier to suspend than when not under such conditions or unconditionally suspending the execution of the subject blur correction, reduction in the quality of the captured image caused by false determination can be suppressed.

### Second Embodiment

Next, the second embodiment of the present invention will be described. The present embodiment can be implemented by the digital camera 1, and the operations in steps S203 and S204 of FIG. 2 are different from that of the first embodiment. Accordingly, the portions that are different from the first embodiment will be focused on in the following description.

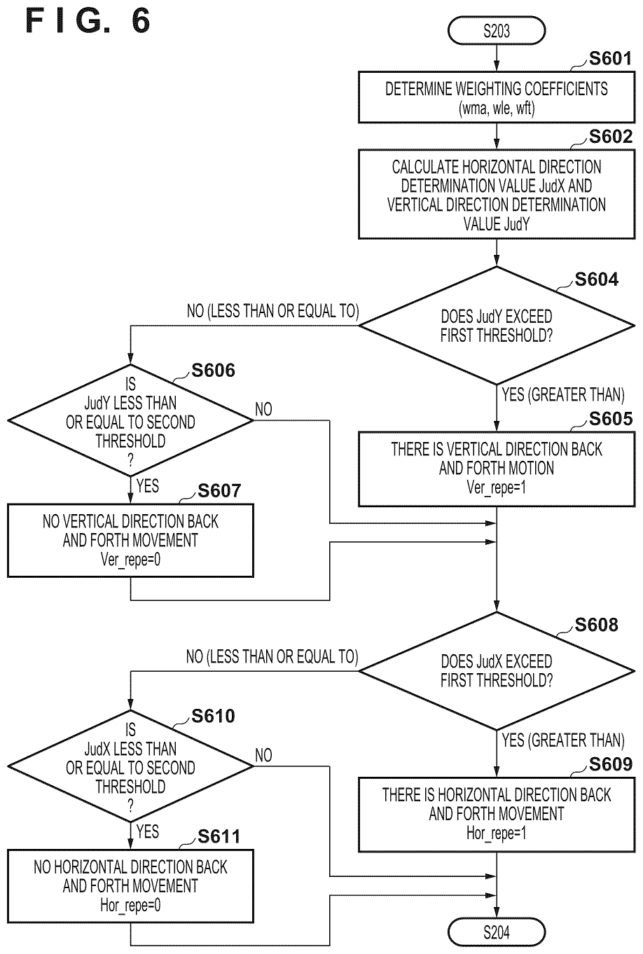

FIG. 5 is a flowchart relating to details of the main subject motion determination processing (step S203 of FIG. 2) according to the present embodiment. In FIG. 5, steps with operations similar to that of the first embodiment are given the same reference number as in FIG. 4A, and descriptions thereof are skipped.

In steps S401 to S407, if there is a back and forth motion in the vertical direction is determined on the basis of an index relating to the motion in the vertical direction, and a value for the variable Ver_repe is set in a similar manner to the first embodiment. Note that in the present embodiment, an index relating to a motion in both directions is not used, and thus step S403 is not executed. After steps S405 and S407 are executed, the CPU 15 executes step S508.

In step S508, the CPU 15 determines if both the index Def10XMAX (n) and the index Def30XMAX (n) of the horizontal direction exceed the first threshold. If the CPU 15 determines that both of the indices of the horizontal direction exceed the first threshold, step S509 is executed. If this is not determined, step S510 is executed.

In step S509, the CPU 15 determines that the motion of the main subject includes a back and forth motion in the horizontal direction and sets a variable Hor_repe to 1. Thereafter, the CPU 15 ends the processing of step S203.

In step S510, the CPU 15 determines if both of the indices Def10XMAX (n) and Def30XMAX (n) of the horizontal direction are equal to or less than the second threshold. If the CPU 15 determines that both of the indices of the horizontal direction are equal to or less than the second threshold, step S511 is executed. If this is not determined, the processing of step S203 is ended without changing the value of Hor_repe.

In step S511, the CPU 15 determines that the motion of the main subject does not include a back and forth motion in the horizontal direction and clears (sets to 0) the variable Hor_repe. Thereafter, the CPU 15 ends the processing of step S203.

In step S204, the CPU 15 references the value of the variables Ver_repe and Hor_repe instead of the status flag of the subject blur correction operation and executes step S205 if the main subject is performing the specific motion. Here, the CPU 15 considers the main subject is being performing the specific motion if the value of the variable Ver_repe and/or the value of the variable Hor_repe is 1. On the other hand, if the main subject is not performing the specific motion, the CPU 15 returns the processing to step S202 and continues or resumes the execution of the subject blur correction.

In steps S205 and S206, the CPU 15 suspends the subject blur correction only in the vertical direction if only the variable Ver_repe is 1 and suspends the subject blur correction only in the horizontal direction if only the variable Hor_repe is 1. In a similar manner, if both the variable Ver_repe and the variable Hor_repe are 1, the CPU 15 suspends the subject blur correction in both the vertical direction and the horizontal direction as in the first embodiment.

Note that in a case where the subject blur correction is cancelled in only the vertical direction or the horizontal direction, the CPU 15 generates subject blur correction position information which includes a fixed value for the direction for which the subject blur correction is cancelled and a value obtained as in step S202 for the direction for which the subject blur correction is not cancelled. The fixed value can be obtained in a similar manner as in step S205 of the first embodiment.

In step S206, the CPU 15 outputs the cropping position obtained in step S205 to the image transformation cropping circuit 28. The image transformation cropping circuit 28 crops the image according to the position indicated by the subject blur correction position information and stores the cropped image in the VRAM 6.

In the present embodiment, if the main subject is performing the specific motion is determined independently for the vertical direction and the horizontal direction. Also, depending on the determination result, the subject blur correction is suspended independently per direction. According to the present embodiment, a similar effect to that obtained by the first embodiment can be obtained. Also, by continuing the subject blur correction for the direction in which the specific motion is not being performed, the effect of the subject blur correction can be maintained.

### Third Embodiment

Next, the third embodiment of the present invention will be described. The present embodiment determines the motion of the main subject independently for the vertical direction and the horizontal direction as in the second embodiment and suspends the subject blur correction independently per direction. In the present embodiment, a plurality of methods are used to determine the motion of the main subject, and a final determination is performed on the basis of the determination results from each method.

Specifically, in the present embodiment, if the main subject is performing the specific motion is determined using the methods 1 to 3 described below. Note that the methods 1 to 3 are examples, and another method may be used. Also, it is sufficient that two or more methods are used.
Method 1: if the main subject is performing a back and forth motion is determined using the frequency characteristics of the detection result (position) of the main subject detection circuit 26. The frequency characteristics can be obtained by a known method such as fast Fourier transform (FFT) or the like. FFT may be performed by the CPU 15 executing a program, or FFT may be performed at high-speeds by providing a dedicated circuit such as a microprocessor including a multiply-accumulate operation device. In any case, the CPU 15 determines if the main subject is performing a back and forth motion on the basis of the frequency characteristics relating to the position of the main subject.
Method 2: if the main subject is performing a back and forth motion is determined using the moving average of the detection result of the main subject detection circuit 26. Specifically, the CPU 15 integrates the absolute value of the difference between the detection result (position) of the main subject detection circuit 26 and the moving average for different integration periods (for example, the first integration period and the second integration period in the first embodiment). Then, the CPU 15 determines if the main subject is performing a back and forth motion on the basis of each integration value.
Method 3: if the main subject is performing a back and forth motion is determined by the CPU 15 on the basis of the distance between the extremums (maximum value and minimum value) of the detection result (position) of the main subject detection circuit 26.

The methods 1 to 3 all have pros and cons.

With method 1, a high detection accuracy can be achieved, but some time is needed to obtain a sufficient detection accuracy. For example, in a case where an output signal of 128 samples is required, approximately 4.2 seconds is required. Also, since the operation load is high, a dedicated processing circuit may be required, but may be unable to be used when there is a resource conflict. Also, the determination accuracy is not high for main subjects with a low number of back and forth motions such as a low frequency, high speed moving object or the like.

An advantage of method 2 is that the back and forth motion of various moving bodies can be determined in a short amount of time and that the operation load is low. However, the accuracy varies depending on the speed of the motion, and the determination accuracy tends to be lower for mid-frequency, mid-speed subjects. Also, method 2 is susceptible to the effects of the amplitude of the back and forth motion, and when attempting to cope with back and forth motion with a small amplitude, the determination parameters need to be dynamically changed.
Method 3, like method 2, can determine back and forth motion in a short amount of time. However, method 3 is susceptible to noise, and a small variation in the main subject detection result may be mistakenly recognized as the extremums or the determination reference of the back and forth motion may tend to be vague.

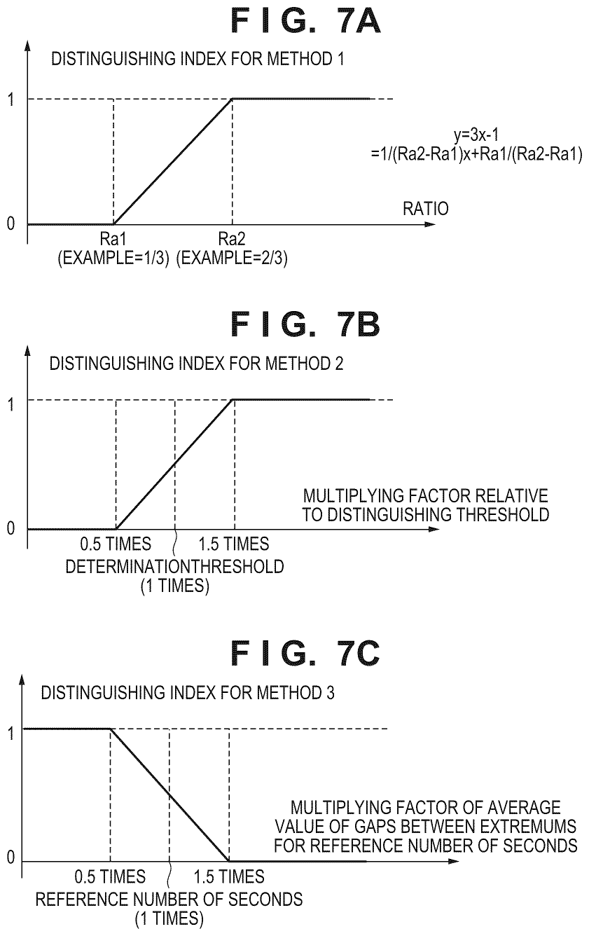

In this manner, since each of the methods has different advantages, in the present embodiment, a final determination result is obtained by taking into account the determination result from each method. For example, by finding the weighted average of the determination results, a final determination result taking into account the determination result of each method can be obtained. The main subject motion determination processing (step S203 of FIG. 2) according to the present embodiment will now be described in detail using the flowchart illustrated in FIG. 6. Here, for the image data of the same frame, determination results from the methods 1 to 3 described above are obtained.

In step S601, the CPU 15 determines the weighting coefficient for each method. Here, the weighting coefficient for method 1 is wft, the weighting coefficient for method 2 is wma, and the weighting coefficient for method 3 is wle (local extremum). The CPU 15 can determine these weightings as follows, for example.

Since the determination accuracy of method 1 increases as the elapsed time increases, the CPU 15 increases the weighting coefficient wft as the elapsed time increases.

Specifically, when FFT starts, the CPU 15 starts measuring the time.

When elapsed time<first predetermined number of seconds (for example 2 seconds), wft=0.

When elapsed time=second predetermined number of seconds (>first predetermined number of seconds) (for example, 4 seconds), wft=first weighting coefficient (for example, 0.55).

Linear interpolation is performed on the section where first predetermined number of seconds≤ elapsed time<second predetermined number of seconds, and wft is determined.

Also, the CPU 15 determines the weighting coefficient for methods 2 and 3 as follows on the basis of the weighting coefficient wft of method 1.

$$w m a = ( 1 - wft ) \times 2 / 3$$

$$wle = ( 1 - wft ) / 3$$

Here, in the section where the elapsed time is equal to or greater than the second predetermined number of seconds, and with the determination accuracy of method 1 at its highest, the weighting coefficient for methods 2 and 3 are determined. Note that the measurement value of the elapsed time is reset when the subject blur correction is resumed or when the FFT resource is unusable during suspension of the subject blur correction.

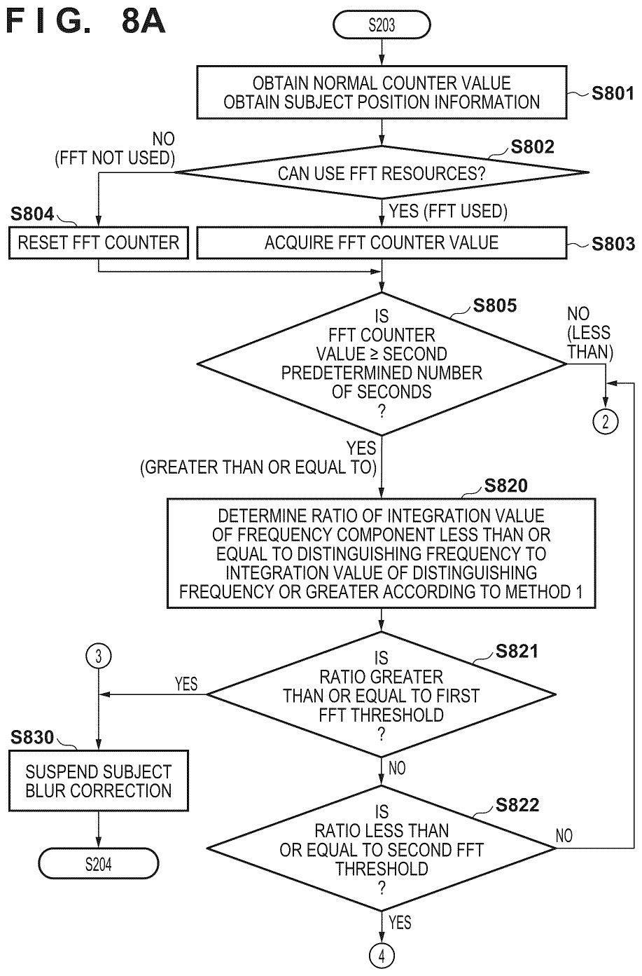

Here, the calculation method of the determination index for methods 1 to 3 will now be described using FIGS. 7A to 7C. The weighting for each method described above is applied to the determination index of the respective method.

A determination index P_FFT from method 1 is calculated by the CPU 15 on the basis of a ratio between the integration value of the frequency component equal to or greater than the determination frequency and the integration value of the frequency component equal to or less than the determination frequency. The determination frequency can be determined on the basis of the frequency, from among the frequency components of the back and forth motion of the main subject, at which the subject blur correction should be suspended.

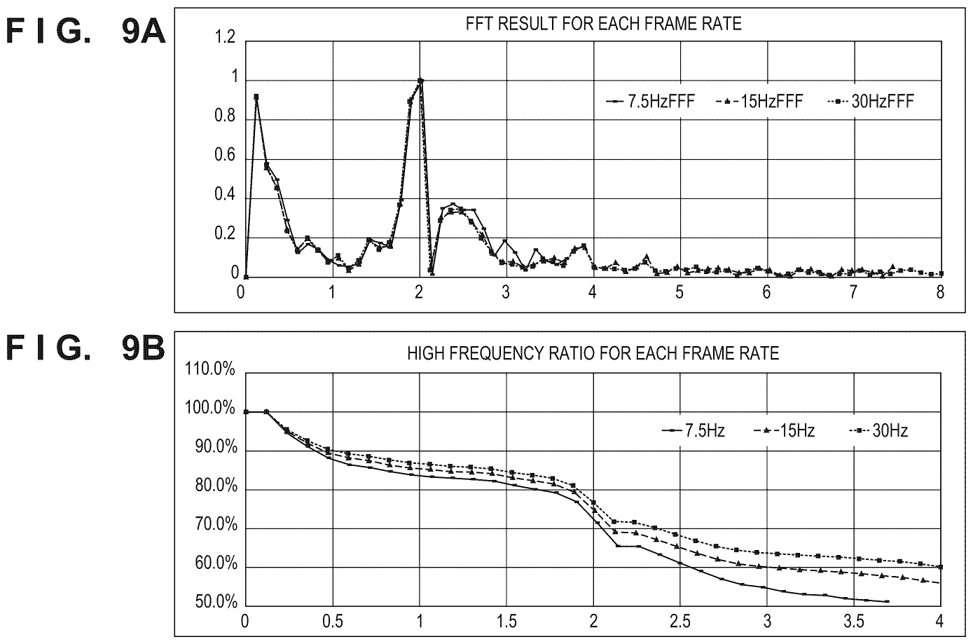

For example, in a case where an FFT result is obtained for each frame rate as illustrated in FIG. 9A, the CPU 15 calculates the determination index P_FFT as follows.

In the case of suspending the subject blur correction for motion with a frequency of 2 Hz or greater, the determination frequency should be set to approximately 1.8 Hz, for example. However, when the frame rate (FFT sampling frequency) is different, the obtained frequency changes. Thus, the determination frequency is set per frame rate.

FIG. 9B illustrates the integration value of the strength of the frequency range equal to or greater than the determination frequency in the case of frame rates of 30 fps, 15 fps, and 7.5 fps. Note that the direct current component is not taken into account for the calculation of the ratio described above.

In a case where the determination frequency at 30 fps is 1.76 Hz, the determination frequency at which approximately the same ratio is obtained at 15 fps and 7.5 fps is 1.54 Hz for 15 fps and 1.19 Hz for 7.5 fps. In a case where the motion frequency of the subject to be detected is 2 Hz or greater, when a condition that the determination frequency is equal to or greater than 1.5 Hz is added, the determination frequency at 7.5 fps becomes 1.55 Hz. For 30 fps and 15 fps, the determination frequency is originally 1.5 Hz or greater, and thus the value described above can be used as is. In this manner, depending on the frame rate, the parameter (determination frequency) for index calculation is changed.

Also, the CPU 15 can calculate the determination index by referencing the relationship between the prestored value of the determination index and the ratio described above as illustrated in FIG. 7A, for example. As illustrated in FIG. 7A, in a section where the ratio of the integration value of the strength of the frequency range equal to or greater than the determination frequency is equal to or less than Ra1 (for example, ⅓), the determination index P_FFT is 0, and in a section where it is equal to or greater than Ra2 (for example, ⅔), the determination index P_FFT is 1. Also, for the ratio between Ra1 and Ra2, linear interpolation is performed to calculate the determination index P_FFT. The relationship illustrated in FIG. 7A can be prestored in the EEPROM 19 as a function or a table, for example. In the example of FIG. 9A, since the ratio 69% is greater than Ra2, the CPU 15 determines that the determination index P_FFT is 1.

Note that the time period in which FFT is performed is a certain time period (for example, 6 seconds) from the start of the measurement of the elapsed time until 1.5 times the second predetermined number of seconds has elapsed. After the certain time period has elapsed, the FFT applying period is shifted backward.

A determination index P_Ma from method 2 is calculated by the CPU 15 on the basis of a determination threshold based on the integration value of the absolute value of the difference between the motion of the main subject for which the subject blur correction should be suspended as described above and the moving average. In other words, it is calculated on the basis of what the value is relative to the threshold corresponding to the problematic back and forth motion of the main subject.

The CPU 15 integrates the absolute value of the difference between the detection result (position) of the main subject detection circuit 26 and the moving average. The CPU 15 calculates the determination index P_Ma according to the multiplying factor of the integration value (first integration value) for the first integration period relative to the determination threshold. As illustrated in FIG. 7B, for example, the CPU 15 determines the determination index P_Ma to be 0 when the integration value is equal to or less than 0.5 times the determination threshold and determines the determination index P_Ma to be 1 when the integration value is equal to or greater than 1.5 times the determination threshold. Also, for the range greater than 0.5 times and less than 1.5 times, the CPU 15 performs linear interpolation and obtains the determination index P_Ma.

The CPU 15 obtains the determination index P_Ma in a similar manner to the integration value (second integration value) for the second integration period. In this case, a determination threshold for the second integration period is used. Here, the used determination threshold changes depending on the frame rate. This is because, as described above, a decrease in the frame rate tends to cause a decrease in the amplitude of the change in position of the main subject region of the section where there is a specific motion, such as back and forth motion and a decrease in the difference between the subject position and the moving average value.

Also, the CPU 15 averages the determination indices P_Ma calculated for the first integration period and the second integration period and obtains the determination index P_Ma from method 2. The integration section (frame number) changes depending on the frame rate, as in the first embodiment.

A determination index P_Le from method 3 is obtained by the CPU 15 as follows.

The CPU 15 detects the maximum value and the minimum value of the detection result (position) of the main subject detection circuit 26. Then, the CPU 15 sequentially obtains the distance between the maximum values and the minimum values close to one another and calculates the average value of the gaps between extremums obtained for a predetermined time period (for example, 2 seconds when the frame rate of the moving image is 30 fps) according to the most recent frame rate.

The predetermined time period can be empirically determined taking into account the accuracy when detecting the distances between the maximum values and the minimum values in the time period and calculating the average value. When the frame rate is reduced, the accuracy of the distance between the maximum value and the minimum value is reduced, making it necessary to increase the number of distances to obtain in order to maintain the accuracy.

Here, the predetermined time period for the reference frame rate is set as the reference value, and the predetermined time period for other frame rates is obtained by multiplying together the reference value and the ratio with the reference frame rate. However, the predetermined time period may be provided with an upper limit and the lower limit taking into account the main frequency of the motion of the subject to be detected and the amount of time needed for detection.

For example, in a case where the predetermined time period for the reference frame rate of 30 fps is 2 seconds, the predetermined time period for 48 fps is 2×⅝=1.25 seconds. In a case where a lower limit value of 1.25 seconds is set taking into account the motion of the subject, the predetermined time period for any frame rate greater than 48 fps is set to 1.25 seconds. The predetermined time period for 15 fps is 4 seconds. In a case where an upper limit value of 4 seconds is set taking into account the amount of time needed for detection, the predetermined time period for any frame rate less than 15 fps is 4 seconds.

Also, the CPU 15 calculates the determination index P_Le according to the multiplying factor of the average value for a predetermined reference number of seconds on the basis of the frequency of the motion of the main subject for which the subject blur correction should be suspended. As illustrated in FIG. 7C, for example, the CPU 15 determines the determination index P_Le to be 1 when the average value is equal to or less than 0.5 times the reference number of seconds and determines the determination index P_Le to be 0 when the average value is equal to or greater than 1.5 times the reference number of seconds. Also, for the range greater than 0.5 times and less than 1.5 times, the CPU 15 performs linear interpolation and obtains the determination index P_Le.

For example, when the frequency of the motion of the main subject for which the subject blur correction should be suspended is 2 Hz or greater, the reference number of seconds can be set to 0.25 seconds. In this case, when the average value of the extremums distance is 0.125 seconds or less, the determination index P_Le is 1, and when the average value of the extremums distance is 0.375 seconds or greater, the determination index P_Le is 0.

Note that in a case where the output of the main subject detection circuit 26 at time t is d [t], the CPU 15 can determine the maximum value and the minimum value of the output as follows. Note that Th is a predetermined threshold for determining the extremum.

Output d [t] satisfying the following is set as the maximum value.

$$d [ t ] >= d [ t + 1 ] + Th and d [ t ] >= d [ t + 2 ] + 2 \times Th and d [ t + 1 ] > d [ t + 2 ]$$

$$and$$

$$d [ t ] >= d [ t - 1 ] + Th and d [ t ] >= d [ t - 2 ] + 2 \times Th and d [ t - 1 ] > d [ t - 2 ]$$

Output d [t] satisfying the following is set as the maximum value.

$$d [ t ] <= d [ t + 1 ] - Th and d [ t ] <= d [ t + 2 ] - 2 \times Th and d [ t + 1 ] < d [ t + 2 ]$$

$$and$$

$$d [ t ] <= d [ t - 1 ] - Th and d [ t ] <= d [ t - 2 ] - 2 \times Th and d [ t - 1 ] \text{><} d [ t - 2 ]$$

The CPU 15 obtains the determination indices for the horizontal direction and the vertical direction for the methods 1 to 3.

Returning to FIG. 6, in step S602, the CPU 15 obtains a horizontal direction determination value JudX and a vertical direction determination value JudY using the following formula on the basis of the weight coefficient and the determination index for each method.

$$Horizontal direction determination value JudX = wft \times P\_FFT ( x ) + w ma \times P\_Ma ( x ) + w le \times P\_Lew1 ( x )$$

$$Vertical direction determination value JudY = wft \times P\_FFT ( y ) + w ma \times P\_Ma ( y ) + w le \times P\_Lew1 ( y )$$

Note that the attached characters (x) and (y) indicate the determination index of the horizontal direction and the vertical direction, respectively.

In this manner, a determination value obtained by adding together the determination indices of the methods 1 to 3 using weighting for each method is obtained for each direction.

Next, in step S604, the CPU 15 determines if the determination value JudY exceeds the first threshold (threshold for determining that the main subject is performing a back and forth motion). If the determination value JudY is determined to be exceeding the first threshold, step S605 is executed. If this is not determined, step S606 is executed.

In step S605, the CPU 15 determines that the motion of the main subject includes a back and forth motion in the vertical direction and sets the variable Ver_repe to 1. Thereafter, the CPU 15 executes step S608.

In step S606, the CPU 15 determines if the determination value JudY is equal to or less than the second threshold (threshold for determining that the motion of the main subject does not include a back and forth motion) less than the first threshold. If the determination value JudY is determined to be equal to or less than the second threshold, step S607 is executed. If this is not determined, step S608 is executed.

In step S607, the CPU 15 determines that the motion of the main subject does not include a back and forth motion in the vertical direction and clears (sets to 0) the variable Ver_repe. Thereafter, the CPU 15 executes step S608.

In step S608, the CPU 15 determines if the determination value JudX exceeds the first threshold (threshold for determining that the main subject is performing a back and forth motion). If the determination value JudX is determined to be exceeding the first threshold, step S609 is executed. If this is not determined, step S610 is executed.

In step S609, the CPU 15 determines that the motion of the main subject includes a back and forth motion in the horizontal direction, sets the variable Hor_repe to 1, and ends the processing of step S203.

In step S610, the CPU 15 determines if the determination value JudX is equal to or less than the second threshold (threshold for determining that the motion of the main subject does not include a back and forth motion) less than the first threshold. If the determination value JudX is determined to be equal to or less than the second threshold, step S611 is executed. If this is not determined, the processing of step S203 ends.

In step S611, the CPU 15 determines that the motion of the main subject does not include a back and forth motion in the horizontal direction, clears the variable Hor_repe (sets to 0), and ends the processing of step S203.

Thereafter, the CPU 15 executes steps S204 to S206 in a similar manner to the second embodiment.

According to the present embodiment, a similar effect to that obtained by the second embodiment can be obtained. Also, if the main subject is performing the specific motion can be determined taking into account the determination result from the plurality of methods. Thus, compared to the second embodiment, the reliability relating to determination the motion can be increased.

### Fourth Embodiment

Next, the fourth embodiment of the present invention will be described. As in the second and third embodiments, in the present embodiment, if the main subject is performing the specific motion is determined independently for the vertical direction and the horizontal direction. Also, as in the third embodiment, the motion of the main subject is determined using the methods 1 to 3.

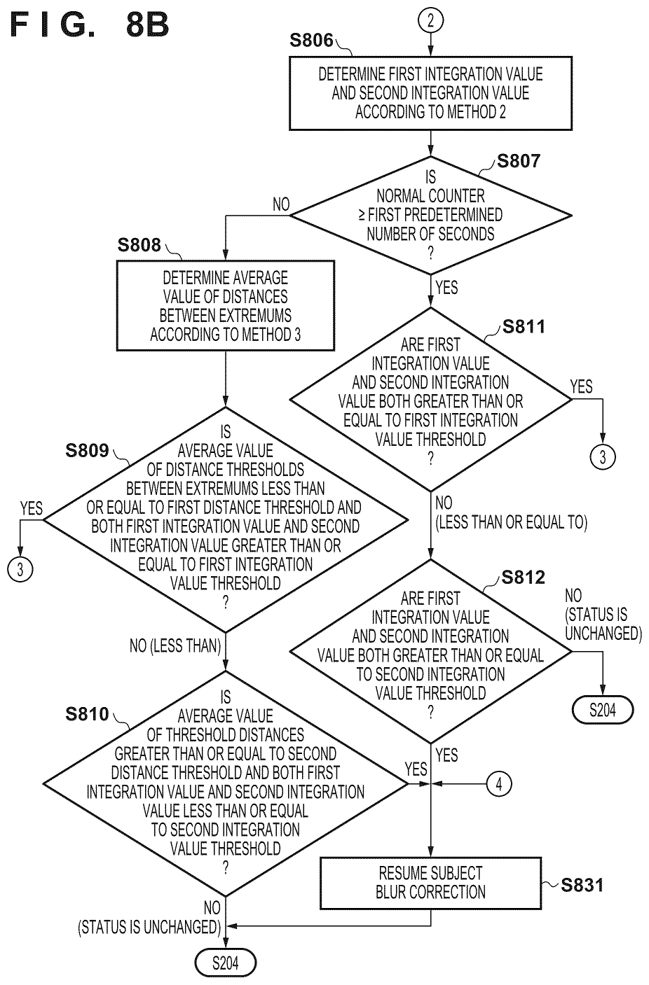

The main subject motion determination processing (step S203 of FIG. 2) according to the present embodiment will now be described in detail using the flowchart illustrated in FIG. 8. Here, for the image data of the same frame, determination results from the methods 1 to 3 described above are obtained.

The operations illustrated in FIG. 8 are executed the same for the horizontal direction and the vertical direction, and thus in the following description, no distinction will be made between the directions. In practice, the operations illustrated in FIG. 8 are executed separately for the horizontal direction and the vertical direction, and a determination result for each direction is obtained.

In step S801, the CPU 15 obtains the detection result from the main subject detection circuit 26 and associates it with the value of a counter for measuring the elapsed time. The counter is different from the counter (FFT counter) for measuring the elapsed time for FFT and is referred to below as a normal counter.

In step S802, the CPU 15 determines if the resources for executing FFT can be used. If it is determined that they can be used, step S803 is executed. If this is not determined, step S804 is executed.

In step S803, the CPU 15 obtains the value of the FFT counter.

In step S804, the CPU 15 resets the value of the FFT counter.

In step S805, the CPU 15 determines if the value of the FFT counter is a value equal to or greater than the second predetermined number of seconds. If it is determined that the value is equal to or greater than the second predetermined number of seconds, step S820 is executed. If this is not determined, step S806 is executed. Accordingly, in a case where FFT execution time is equal to or greater than the second predetermined number of seconds, method 1 with sufficiently high detection accuracy is prioritized for execution. In a case where the FFT execution time is less than the second predetermined number of seconds, method 2 or 3 is prioritized for execution.

In step S806, the CPU 15 obtains a first integration value and a second integration value according to method 2 as described in the third embodiment.

In step S807, the CPU 15 determines if the value of the normal counter is equal to or greater than the first predetermined number of seconds which is less than the second predetermined number of seconds. If it is determined that the value is equal to or greater than the first predetermined number of seconds, step S811 is executed. If this is not determined, step S808 is executed.

Accordingly, in a case where the elapsed time (processing frame number) from the start of processing is equal to or greater than the first predetermined number of seconds, method 2 is prioritized for execution. In a case where the elapsed time is less than the first predetermined number of seconds, method 3 or 1 is prioritized for execution.

In the processing from step S808 onward, the CPU 15 determines the motion of the main subject using method 3. In step S808, as described in the third embodiment, the CPU 15 obtains the average value of the distances between the maximum values and the minimum values for the output of the main subject detection circuit 26 according to method 3.

In step S809, the CPU 15 determines if the condition that the average value obtained in step S808 is equal to or less than a first distance threshold and the condition that both the first and second integration value obtained in step S806 are equal to or greater than a first integration value threshold are satisfied. If the CPU 15 determines that the conditions are satisfied, step S830 is executed. If the CPU 15 does not determine this, step S810 is executed.

In step S830, the CPU 15 determines to suspend the subject blur correction. The CPU 15 sets both the variable Ver_repe and the variable Hor_repe to 1, for example, and ends the processing of the step S203.

In step S810, the CPU 15 determines if the condition that the average value obtained in step S808 is equal to or greater than a second distance threshold longer than the first distance threshold and the condition that both the first and second integration value obtained in step S806 are equal to or less than a second integration value threshold smaller than the first integration value threshold are satisfied. If the CPU 15 determines that the conditions are satisfied, step S831 is executed. If the CPU 15 determines that the conditions are not satisfied, the processing of the step S203 ends without changing the status of the subject blur correction.

In step S831, the CPU 15 determines to resume the subject blur correction. The CPU 15 sets both the variable Ver_repe and the variable Hor_repe to 0, for example, and ends the processing of the step S203.

From step S811 onward, the motion of the main subject is determined using method 2. In step S811, the CPU 15 determines if both the first and the second integration value are equal to or greater than the first integration value threshold. If it is determined that the values are equal to or greater than the first integration value threshold, step S830 is executed. If this is not determined, step S812 is executed.

In step S812, the CPU 15 determines if both the first and the second integration value are equal to or less than the second integration value threshold less than the first integration value threshold. If it is determined that the values are equal to or less than the second integration value threshold, step S831 is executed. If the CPU 15 determines that the conditions are not satisfied, the processing of the step S203 ends without changing the status of the subject blur correction.

In the processing from step S820 onward, the CPU 15 determines the motion of the main subject using method 1. In step S820, as described in the third embodiment, the CPU 15 obtains the ratio of the integration value of the frequency component equal to or less than the determination frequency to the integration value of the determination frequency or greater according to method 1.

In step S821, the CPU 15 determines if the ratio obtained in step S820 is equal to or greater than a first FFT threshold. If it is determined that the ratio is equal to or greater than the first FFT threshold, step S830 is executed. If this is not determined, step S822 is executed.

In step S822, the CPU 15 determines if the ratio obtained in step S820 is equal to or less than a second FFT threshold less than the first FFT threshold. If it is determined that the ratio is equal to or less than the second FFT threshold, step S831 is executed. If this is not determined, step S806 is executed. Accordingly, in a case where the specific motion cannot be determined via the first method, method 2 or 3 is used to determine the specific motion.

Thereafter, the CPU 15 executes steps S204 to S206 in a similar manner to the second embodiment.

Also, in the present embodiment, depending on the imaging status, such as the frame rate or the like, the parameter for determination is changed. The second predetermined number of seconds compared to the value of the normal counter is changed depending on the frame rate. This is because the accuracy of the average value calculated by detecting the maximum values and the minimum values changes depending on the frame rate. As in the third embodiment, the predetermined number of seconds for the reference frame rate is set as the reference value, and the predetermined number of seconds for other frame rates is obtained by multiplying together the reference value and the ratio with the reference frame rate. Note that the second predetermined number of seconds is a number of seconds relating to the FFT accuracy and is not dependent on the frame rate.

Also, the first and second distance threshold used in steps S808 and S809 are the same in terms of the number of seconds, but the data number is changed depending on the frame rate. The formula for determination the maximum values and the minimum values of the output is a function of time t for the sake of convenience, but it can be expressed as a function of the data number. In this case, the data number is changed depending on the frame rate taking into account the data number per the same amount of time.

Also, the first and second integration value threshold used in steps S808, S809, S811, and S812 are dependent on the frame rate and can be empirically determined in advance, as in the first embodiment.

According to the present embodiment, a similar effect to that obtained by the second embodiment can be obtained. Also, if the main subject is performing the specific motion can be determined using a plurality of methods. Thus, compared to the second embodiment, the reliability relating to determination the motion can be increased. Also, by changing the method to be prioritized for execution according to the elapsed time, the motion can be determined using the appropriate method.

### OTHER EMBODIMENTS

In the second to fourth embodiments, instead of obtaining a moving average using method 2, a filter including a delay effect may be used to obtain the integration value of the absolute value of the difference between the output of the main subject detection circuit 26 and the output of the filter.

Also, in the embodiments described above, in a case where the CPU 15 determines that the user has intentionally changed the main subject (for example, when a panning operation is detected), the subject blur correction may be suspended until a new main subject is detected.

For example, in a case where the change amount of the position of the main subject region obtained from the output of the main subject detection circuit 26 is equal to or greater than a predetermined threshold, the CPU 15 can determine that the user has intentionally changed the main subject. A similar determination can be made in a case where the difference between the motion of the main subject and the motion of the digital camera 1 obtained from the output of the motion vector detection circuit 27 and the blur detection circuit 13 is equal to or greater than a predetermined threshold.

In the embodiments described above, the present invention is implemented using the interchangeable-lens digital camera 1. However, the present invention can be implemented with any electronic device that uses a fixed lens.

Note that one or more of the operations described as being implemented by the CPU 15 in the embodiments described above may be implemented by a different piece of hardware, such as an ASIC or the like.

In the embodiments described above, a determination result of if the main subject is performing a motion including a back and forth motion is used to control the subject blur correction. However, the determination result may be used for a different purpose. Thus, the present invention may be implemented as an image processing apparatus or image processing method that independently executes the motion determination processing according to the embodiments described above.

Also, in the embodiments described above, the subject blur is corrected by controlling the position of where the image transformation cropping circuit 28 crops the image. However, the subject blur may be corrected by causing at least one of the optical system included in the interchangeable lens and the image sensor 3 included in the digital camera 1 to move. Also, the subject blur may be corrected using a drive apparatus, which is integrally formed with the digital camera 1 or detachably mounted on the digital camera 1, that can rotate the digital camera 1 about a pan axis and a tilt axis using at least one motor. With a configuration that executes subject blur correction using a drive apparatus for an interchangeable lens or pan/tilt, a microprocessor provided in the drive apparatus for an interchangeable lens or pan/tilt executes the control of the subject blur correction. In other words, the subject blur detection is preferably executed by the image capture apparatus, but in the electronic device that controls the correction of the detected subject blur, a device other than an image capture apparatus without an image capture function may be included.

Note that the control according to the embodiments described above can be represented as follows. The CPU 15 (controlling means) controls the processing for suppressing a change in the position of the main subject across a plurality of images of a moving image captured using the image sensor 3 (image capture means). A first motion is defined as the main subject repeatedly moving in a first direction and a second direction in the reverse direction to the first direction relative to the image capture means. In a case where the main subject is performing the first motion during moving image capture, the controlling means controls the processing to suppress the change so that the degree of suppressing the change in position of the main subject is less than in a case where the main subject is performing a second motion different from the first motion relative to the image capture means during moving image capture.

The effects of the embodiments described above can be confirmed by the following comparison. First, put the digital camera 1 in a fixed and non-moving state by using a tripod or the like. Next, with the digital camera 1 in a non-moving state, capture a moving image (first moving image) in which the main subject, relative to the digital camera 1, is performing a motion (an example of the first motion) of moving repeatedly back and forth in the first direction and the second direction, the reverse direction of the first direction, for a predetermined period and a predetermined amount of movement. Next, with the digital camera 1 in a non-moving state, capture a moving image (second moving image) in which the main subject, relative to the digital camera 1, is performing a motion (an example of the second motion) of moving in the first direction a predetermined amount of movement. When the embodiments described above are implemented, the change in the position of the main subject across images is greater in the first moving image compared to the second moving image. Here, the first direction and the second direction are preferably directions close to the directions orthogonal to the optical axis of the digital camera 1 as opposed to the directions parallel with the optical axis of the digital camera 1.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-088074, filed May 29, 2023 and Japanese Patent Application No. 2024-025573, filed Feb. 22, 2024, which are hereby incorporated by reference herein in their entirety.

What is claimed is:

1. An image capture apparatus that performs subject blur correction for suppressing a positional change in time of a main subject in an image, comprising:
one or more processors that execute a program stored in a memory and thereby function as:
a determination unit configured to determine if a motion of the main subject is a specific motion; and
a control unit configured to unit, in a case where the motion of the main subject is determined unit to be the specific motion, control the image capture apparatus so as to make a degree of subject blur correction less than that of before the specific motion is determined.

2. The image capture apparatus according to claim 1, wherein when the motion of the main subject is not determined to be the specific motion, the controlling unit controls the image capture apparatus to make the degree of the subject blur correction equal to that of before the specific motion is determined.

3. The image capture apparatus according to claim 1, wherein the one or more processors further function as:
a detection unit configured to detect a region of a main subject to be targeted for the subject blur correction from an image; and
an obtaining unit configured to obtain a target position of the subject blur correction on a basis of a position of the region detected by the detecting unit, wherein
the determination unit determines if the motion of the main subject is the specific motion on a basis of a difference between the position of the region detected by the detection unit and the target position.

4. The image capture apparatus according to claim 3, wherein
the obtaining unit obtains the target position by obtaining a position obtained by applying low-pass filter processing to the position of the region detected by the detecting unit as the position of the main subject.

5. The image capture apparatus according to claim 1, wherein the determination unit determines if the motion of the main subject is the specific motion for each of different directions.

6. The image capture apparatus according to claim 1, wherein the specific motion is a back and forth motion.

7. The image capture apparatus according to claim 1, wherein one or more parameters used to determine if the motion of the main subject is the predetermined specific motion includes a variable value.

8. The image capture apparatus according to claim 7, wherein the parameter including the variable value includes a value based on any one of an imaging frame rate, an exposure time per frame, and brightness of a captured scene.

9. The image capture apparatus according to claim 1, wherein in a case where an image capture mode for capturing a non-moving object is set, the controlling unit controls the image capture apparatus so that the degree of the subject blur correction is easier to be reduced than when the image capture mode is not set.

10. The image capture apparatus according to claim 1, wherein
the controlling unit controls the image capture apparatus so that the larger a magnification or focal length at a time of capture is, the easier it is to reduce the degree of the subject blur correction.

11. The image capture apparatus according to claim 1, wherein
the controlling unit controls the image capture apparatus so that the degree of the subject blur correction is easier to reduce when background contrast of the main subject is high.

12. The image capture apparatus according to claim 9, wherein the controlling unit controls the image capture apparatus to suspend execution of the subject blur correction.

13. The image capture apparatus according to claim 1, wherein in any one case including a capturing frame rate being equal to or less than a predetermined value, an exposure time per frame being equal to or greater than a predetermined number of seconds, a brightness of a captured scene being equal to or less than a threshold, and a capturing sensitivity being greater than a predetermined sensitivity, the controlling unit controls the image capture apparatus to suspend execution of the subject blur correction.

14. An electronic device, comprising:
one or more processors that execute a program stored in a memory and thereby function as:
a controlling unit that controls processing to suppress a change in a position of a main subject across a plurality of images of a moving image obtained using an image capture unit, wherein
in a case where the main subject is performing a first motion of repeatedly moving back and forth in a first direction and a second direction, which is a reverse direction of the first direction, relative to the image capture unit during moving image capture, the controlling unit controls the processing so that a degree of suppressing the change in the position of the main subject is less than in a case where the main subject is performing a second motion different from the first motion relative to the image capture unit during moving image capture.

15. The electronic device according to claim 14, wherein the processing includes suppressing the change in the position of the main subject by changing a position where a partial image including the main subject is cropped from an image obtained using the image capture unit.

16. The electronic device according to claim 14, wherein the controlling unit reduces a degree of suppressing the change in the position of the main subject in the processing when the motion of the main subject changes from the second motion to the first motion.

17. The electronic device according to claim 16, wherein the controlling unit increases the degree when the motion of the main subject changes from the first motion to the second motion after the degree has been reduced.

18. The electronic device according to claim 14, wherein the processing is executed when the main subject is performing the second motion, and the processing is suspended when the motion of the main subject has changed from the second motion to the first motion.

19. A control method executed by an image capture apparatus capable of subject blur correction for suppressing a change in a position of a main subject in an image, comprising:
determining if a motion of the main subject is a predetermined specific motion; and
in a case where the motion of the main subject is determined to be the specific motion, controlling the image capture apparatus to make a degree of subject blur correction less than that of before the specific motion is determined.

20. A control method executed by an electronic device that controls processing to suppress a change in a position of a main subject across a plurality of images of a moving image obtained using an image capture unit, comprising:
in a case where the main subject is performing a first motion of repeatedly moving back and forth in a first direction and a second direction, which is a reverse direction of the first direction, relative to the image capture unit during moving image capture, controlling the processing so that a degree of suppressing the change in the position of the main subject is less than in a case where the main subject is performing a second motion different from the first motion relative to the image capture unit during moving image capture.
